(19) United States
(12) Patent Application Publication
(10) Pub. No.: US 2022/0044080 A1
(43) Pub. Date: Feb. 10, 2022

(54) Recognition method and recognition system for unambiguously recognizing an object

(71) Applicant: ThePeople.de GmbH, Flein (DE)

(72) Inventors: Carl Michael NÄGELE, Flein (DE); Rudolf Andreas FISCHER, Flein (DE)

(21) Appl. No.: 17/395,638

(22) Filed: Aug. 6, 2021

(30) Foreign Application Priority Data
Aug. 7, 2020 (DE) 10 2020 120 962.2

(51) Int. Cl. G06K 9/68; G06K 9/62; G06N 20/00

(52) U.S. Cl. CPC G06K 9/6878; G06N 20/00; G06K 9/628; G06K 9/6262

(57) ABSTRACT

The presented invention relates to a computer-implemented recognition method (100) for unambiguously recognizing an object. The recognition method (100) comprises a first determining step (101) for determining, by means of a first optical sensor (201) at a first point in time, reference information by capturing a number of symbols applied to a reference object, a training step (103) for training a machine learner on the basis of the reference information and a provided ground truth which assigns respective reference information to a first class or a further class, a second determining step (105) for determining, by means of a second optical sensor (205) at a second point in time, sample information by capturing a number of symbols applied to a sample object, an assigning step (107) for the assigning of the sample information to the first class or the further class by the machine learner, and an outputting step (109) for outputting a validation signal in case the machine learner assigns the sample information to the first class.

Furthermore, the presented invention relates to a recognition system (200).

The presented invention relates to a recognition method and a recognition system for unambiguously recognizing an object.

Numerous objects, such as consumer goods, are produced in large numbers in industrial processes, also referred to as “mass production processes”, in which almost identical objects are created.

Product counterfeiters, in particular, produce objects that are intended to resemble an object from an original manufacturer as closely as possible. With the use of similar production processes it is becoming increasingly difficult to distinguish original goods from counterfeits.

Usually, unambiguous markers such as adhesive strips or punch-outs are applied to an object in order to make it possible to recognize a particular or specific object from a plurality of objects produced in a mass production process. If an object is missing a marker, it can be assigned a false negative classification, which classifies an original object as a counterfeit object.

Furthermore, the application of markers is time-consuming and changes the properties of an object, such as its water resistance, because its surface may be damaged.

Furthermore, it may be desirable for a user of an object to unambiguously recognize or identify his specific object, for example, in order to assign a unambiguous digital identifier to it. Such a unambiguous digital identifier can be used, for example, to use a manufacturer's service and/or to log a status of the object.

Against this background, it is an object of the presented invention to provide a possibility for unambiguously recognizing an object from a plurality of objects produced by means of the same manufacturing process, but with different industrial equipment or machines, without damaging its surface. In particular, one object of the presented invention is to provide a possibility for unambiguously recognizing and digitally processing an object from a plurality of objects produced by means of the same manufacturing process, but with different industrial equipment or machines.

The aforementioned object is solved by the respective subject matter of the independent claims. Embodiments of the invention are apparent from the description, the figures and the dependent claims.

In a first aspect, a computer-implemented recognition method for unambiguously recognizing an object is presented. The recognition method comprises a first determining step for determining, by means of a first optical sensor at a first point in time, reference information of at least one reference object by capturing a number of symbols applied to a respective reference object, a training step for training a machine learner on the basis of the reference information and a provided ground truth which assigns the respective reference information to a first class, for example, to a class “valid”, or to a further class, for example, to a class “not valid”, a second determining step for determining, by means of a second optical sensor at a second point in time, sample information by capturing a number of symbols applied to the object to be recognized, an assigning step for the assigning of the sample information to the first class or to the further class by the machine learner, and an outputting step for outputting a validation signal in case the machine learner assigns the sample information to the first class.

In the context of the presented invention, a symbol is to be understood as a character, such as a letter or a number. In an embodiment of the present invention, a symbol may have a known form, such as an Arabic numeral, or an unknown or subjectively designed form. In possible embodiments, a symbol may also manifest itself in light reflections, corners, edges, seams, welds, embossing, curvatures, folds, soiling, repulsions, and/or deformations.

In the context of the presented invention, a machine learner means a computer program executed or executable by a processor of a computer system and configured to assign data from a provided data set, such as the aforementioned reference information and/or sample information, to a class of a plurality of classes. The machine learner provided according to the invention may be, for example, an artificial neural network, a support vector machine, or any other algorithm suitable for assigning data to a class of a plurality of classes.

The machine learner provided according to the invention is trained in a training step by means of a ground truth, i.e., a specified classification of training data into respective classes. The ground truth may be specified by a user, for example.

To train the machine learner provided according to the invention, reference information is collected as training data in a first determining step. Reference information can be determined by a manufacturer during a manufacturing process, for example, by capturing a respective reference object by means of a first optical sensor, such as an image capture unit. The reference information of a respective reference object is assignable to a specific machine of the manufacturer used in the manufacturing process. The manufacturer can also use different machines in the manufacturing process in parallel for the parallel production of objects and thus determine for the different machines, in the first determining step, respective reference information for respective reference objects produced by the different machines.

In particular, it is provided that the reference information comprises measurement data from symbols arranged or applied on a respective reference object. In particular, the reference information may comprise image information of a code printed or stamped on the respective reference object, such as a manufacturing date, a bar code or matrix code, for example, a BAR code and/or EAN code for a European Article Number.

Once the machine learner provided according to the invention is trained, it can be used for an assigning step in which the machine learner assigns sample information determined in a second determining step to a first class or to a further class. For example, the first class can be a class “valid” and the further class can be a class “not valid”. Since the ground truth comprises information about whether respective sample information is to be assigned to respective reference information, the trained machine learner is configured to assign respective sample information to the first class if it matches the reference information used for training which was assigned to the first class, or if it is to be assigned to such reference information according to the ground truth. Thus, based on the assignment of the sample information to a respective class, a user or a system can recognize whether the sample information corresponds to the reference information also assigned to the first class and, in the case of the object to be recognized, whether a valid object is present, i.e., for example, an object produced by a specific machine of a manufacturer, or whether another object is present, in which latter case the sample information differs from the reference information assigned to the first class.

By training the machine learner with the ground truth, the machine learner is specifically adapted to the reference information evaluated by the ground truth in such a way that it determines specific features for a class, such as the smallest irregularities in the contour of a symbol or deviations in the position of a symbol on an object, which are caused by a printer for applying respective symbols to an object. Such deviations or irregularities can, for example, be specific to a manufacturer's machine. Accordingly, such specific features can be used to determine whether or not an object to be recognized has been manufactured by means of such specific machine.

If specific features are not present in respective sample information or are not particularly pronounced, the machine learner will assign the sample information to the further class, for example.

The ground truth provided according to the invention requires a logic used for an assignment of sample information to a respective class by the machine learner. Accordingly, a ground truth optimized for, for example, printer-related deviations can configure the machine learner to consider or determine especially printer-related deviations when making the assignment.

As soon as the machine learner according to the invention assigns respective sample information, and, as a result, a respective object to be recognized, to the first class or the further class, a corresponding signal can be output via an output unit, such as, for example, a display and/or a signal lamp and/or a loudspeaker and/or a communication interface. In case the respective sample information is assigned to the first class, the validation signal, for example, a signal “valid”, is output, and in case the respective sample information is assigned to the further class, a signal “not valid” can be output.

In particular, a signal generated in response to an assignment of sample information to a class can be transmitted to another system, such as a manufacturer's management server.

Furthermore, a signal generated in response to an assignment of sample information to a class can be assigned to a record of the object to be recognized. In particular, a unambiguous digital identifier, such as a code, can be assigned to the object to be recognized if the sample information of the object to be recognized is assigned to the first class. This can be used, for example, to indicate that the object to be recognized or the recognized object was produced by a specific machine of a manufacturer.

In one possible embodiment of the presented recognition method, it may be provided that the first sensor and the second sensor are identical.

In the case where the first sensor and the second sensor are identical, the sensor may be embedded in a manufacturing process and, in the first determining step, capture as reference objects a first number of objects manufactured by the manufacturing process. Subsequently, a further number of objects manufactured by the manufacturing process can be captured as sample objects and assigned to the first class or the further class by means of the machine learner according to the invention. Accordingly, such a process can recognize production errors, for example.

Furthermore, using a respective sensor, a manufacturer can recognize an object previously manufactured and determined as a reference object as an object manufactured by the manufacturer by supplying the machine learner with sample information of the object to be recognized and reference information of the same object.

Furthermore, using a respective sensor to carry out the presented recognition method, a user can determine measurement data of any reference object as reference information, and reconcile measurement data of any object to be recognized, hereinafter also referred to as a sample object, as sample information with the reference information, such that the user or a manufacturer who manages a result of an assignment based on the sample information can check whether or not the sample object is the reference object or at least an object manufactured with the same machine as the reference object.

In another possible embodiment of the presented recognition method, it may be provided that the second sensor is formed as an integral part of a mobile computing unit.

By using two different sensors, for example, a first sensor embedded in a manufacturer's manufacturing process for an object and a second sensor in a mobile computing unit, a user of the mobile computing unit can generate, at any location, sample information that is supplied to a machine learner trained on the basis of reference information determined by the first sensor. Accordingly, any user, at any location, can validate his object to be recognized based on reference information provided by a respective manufacturer and a correspondingly trained machine learner, i.e., determine whether his object to be recognized was produced by the respective manufacturer or by a specific machine of the respective manufacturer.

In another possible embodiment of the presented recognition method, it may be provided that the ground truth is dynamically updated and the machine learner is dynamically retrained.

By updating a ground truth and correspondingly retraining of the machine learner, the machine learner can be adapted to current conditions. For example, when components, such as a printer, are replaced in a manufacturing process for a respective object, the machine learner can be retrained based on correspondingly updated and possibly newly determined reference information.

In particular, in cases where the reference information is determined based only on a single reference object, the ground truth can automatically assign such reference information to the first class so that a respective object to be recognized can be assigned to the further class if it is different from the reference object. Accordingly, a user can, for example, mark a reference object with a handwritten symbol and capture it in a first determining step using a smartphone. The determined reference information is then assigned to the first class as ground truth. In a second determining step, the smartphone captures the reference object or another object as the object to be recognized, and the determined sample information is supplied to the machine learner. The machine learner assigns the sample information to the first class or the further class. If the object to be recognized which is captured in the second determining step is the reference object, the machine learner will assign the sample information to the first class, otherwise to the further class. Accordingly, the handwritten symbol can be used to recognize the reference object, especially in combination with other features of the reference object.

In another possible embodiment of the presented recognition method, it may be provided that the recognition method comprises a preprocessing step for preprocessing the reference information and/or the sample information before it is supplied to the machine learner, and wherein the preprocessing step comprises at least one process of the following list of processes: Distinguishing between symbol information and background information by means of a symbol recognition algorithm, recognizing individual symbols using a symbol recognition algorithm, converting image information into spectral information by means of a Fourier transformation.

Preprocessing of information is suitable for optimizing the accuracy with which information, i.e. reference information or sample information, is assigned to a respective class. In particular, the preprocessing can be a selection of sensor data from a plurality of sensor data, such as a selection of an image section from an image. For example, only image data that a symbol recognition algorithm, such as a so-called “OCR” algorithm, has recognized as belonging to a symbol can be selected. Accordingly, an image section depicting a code, for example, can be selected and the corresponding information supplied to the machine learner.

Furthermore, data or sample information or reference information to be supplied to the machine learner can be preprocessed by means of mathematical transformations, such as a Fourier transformation, so that the machine learner considers spectral information to a particularly high degree.

In addition or alternatively to a mathematical transformation, a filtering algorithm can be applied to respective information to be provided to the machine learner, for example, to filter out information known to be irrelevant. Such filter algorithms may comprise, for example, color filters and/or frequency filters.

In particular, a filtering algorithm can be used which provides only a number of predetermined symbols to the machine learner and filters out all information which is not to be assigned to the number of predetermined symbols.

To prevent a user from manipulating an evaluation of the machine learner, it may be provided that various filters are applied, randomly or according to a predetermined logic, to respective determined sample information or reference information. The machine learner can be adapted depending on a respectively applied filter, for example, by selecting a kernel function according to the respectively applied filter. The kernel function may have been trained on the basis of reference data which have been processed with the respectively applied filter.

In a further possible embodiment of the presented recognition method, it may be provided that the reference information is determined by an entity classified as trustworthy in a manufacturing process of the respective reference object and the sample information is determined by an entity not classified as trustworthy outside a manufacturing process of the object to be recognized.

A trustworthy entity, such as a server operated by a manufacturer of a product, can provide a trustworthy database in the form of reference information that can be used as a basis for reconciliation with further data, for example, data provided by a user as sample information.

In a further possible embodiment of the presented recognition method, it may be provided that the recognition method comprises a verification step in which respective first sample information provided by a specific user is evaluated by means of a further machine learner, wherein the further machine learner is trained on the basis of second sample information already provided by the specific user in the past and assigns the first sample information to the first class or the further class.

A verification step by means of a further machine learner that is specifically trained for a respective user, i.e. that has been trained or is trained on the basis of sample information which has already been provided in the past by, for example, a device of a user or by an identifier of a user, can detect a double recognition attempted by the user, i.e. a process in which a user repeatedly attempts to feed the same object to be recognized to the recognition method according to the invention. Accordingly, a warning message can be issued in case the further machine learner assigns the sample information provided in the past to a class “identical”. A ground truth for training the further machine learner can be provided automatically, since sample information already provided in the past has to be assigned to the class “identical”. Accordingly, the further machine learner can be trained very specifically on the sample information provided in the past.

When providing a further machine learner with sample information already provided in the past, the sample information can be preprocessed by means of a preprocessing step, analogous to a preprocessing process for the machine learner provided according to the invention, in order to minimize, for example, environmental influences, in particular different incidences of light or operating influences, such as different viewing angles. To minimize environmental influences, preprocessing by means of a mathematical transformation, in particular a Fourier transformation, has proven to be particularly suitable. Alternatively or additionally, respective sample information can be selected from a totality of sample information in a preprocessing step.

In a further possible embodiment of the recognition method presented, it can be provided that the ground truth assigns reference information showing a deviation of respective, in particular printed reference symbols from an ideal symbol, which deviation is greater than a validation threshold, to the “not valid” class, and assigns reference information showing a deviation of respective, in particular printed reference symbols from an ideal symbol, which deviation is less than or equal to the validation threshold, to the first class.

A ground truth can be provided automatically by means of a validation threshold, which, for example, specifies, in percent, a deviation of respective data sets to be compared. The validation threshold can be specified by a user, such as a manufacturer, since it influences a trustworthiness or a quality of the presented recognition method.

In another possible embodiment of the presented recognition method, it may be provided that the machine learner is trained on the basis of reference information comprising specific features corresponding to deviations of at least one symbol applied to the respective reference object from an ideal symbol.

By specifying reference information for training the machine learner provided according to the invention, the machine learner can be optimized for recognizing specific features present in the specified reference information, such as a printing system's special printed image of letters which deviates from an ideal symbol, for example, due to minor irregularities. Accordingly, such an optimized or trained machine learner can recognize whether respective sample information has been generated by a respective printing system, such as, for example, a manufacturer's own print head or another print head, and assign the sample information accordingly, for example, to the first class if the sample information has been generated by the manufacturer's own print head.

In another possible embodiment of the presented recognition method, it may be provided that the specific features or the deviations are selected from: Deviations in symbols applied to a respective reference object from respective ideal symbols, in particular differences in dots, omissions, smudges, chipping, embossing, abrasion, in particular in the case of printed, stamped, punched, lasered, engraved or embossed characters, graphic symbols and/or codes, and/or positional deviations of symbols applied to a respective reference object, in particular labels, shrink films and/or imprints in relation to a reference point on the reference object, and/or positional deviations of symbols applied to a respective reference object from markings or from object components, in particular from corners, edges, closures and/or seams of the object, and/or deviations in reflections, light and/or shadow cast, in particular a shadow cast of a deformable packaging as respective reference object, deviations of corners, edges, seams, welds, embossing, curvatures, folds, soiling, repulsions and/or deformations of a respective reference object, and/or color deviations of a respective reference object, and/or deviations of contents of a transparent or translucent object as reference object, and/or deviations in a printing substrate structure, labels, films and/or product wrappings of a respective reference object.

In a second aspect, the presented invention relates to a recognition system. The recognition system comprises a first optical sensor configured to determine reference information of at least one reference object by capturing at a first point in time a number of symbols applied to a respective reference object, a training module configured to train a machine learner on the basis of the reference information and a provided ground truth which assigns respective reference information to a first class or a further class, a second optical sensor configured to determine, at a second point in time, sample information by capturing an object to be recognized, i.e. a sample object, wherein the sample object has a number of sample symbols, in particular printed sample symbols, a classification module configured to assign the sample information to the first class or the further class by means of the machine learner, and an output unit for outputting a validation signal in case the machine learner assigns the sample information to the first class.

In particular, the presented recognition system is used to carry out the presented recognition method.

It is further possible that the reference object, as a package or packaging for a content, is formed and/or to be designated as a further object. It is possible that for training the described machine learner, reference information of the package and/or on the package, which reference information is usually generated by machine during the manufacturing process of the package, for example, is determined by the manufacturer and/or collected, for example, in a database, by capturing a respective package as a reference object by means of the first optical sensor, such as an image capture unit, for example. Specific features of the reference object formed as a package are taken into account as reference information, wherein this reference information, for example, the specific features, can usually comprise deviations of symbols as reference symbols from a respective ideal symbol provided for this purpose, wherein ideal symbols are defined as symbols, for example, in the database, which can be updated by the machine learner. It is possible that a visually visible and/or a functional feature of the package is/are used as the symbol. This may be an opening and/or closure of the package.

The package can be designed as a reference object for storing a filling material, for example, a solid flowable solid or a liquid, as the contents of the package, wherein such a filling material can also be designed as food and/or a consumable. A solid flowable filling material is, for example, ground coffee, coffee in the form of coffee beans, rice, sugar, salt or flour. A liquid flowable product can be a beverage, for example, a ready-prepared coffee. A respective filling material can be filled into the package through the opening and also removed from the package through the opening. Thus, it is possible that the package is designed as a reference object for holding coffee as a possible food and/or consumable. It is further possible that the opening may be formed or may be designated as a valve of the package. Typically, such an opening has a small slot, which usually has a machine-specific shape and/or position as a specific feature on the package. Such a position and/or shape as a specific feature on the object, for example, the package or packaging, depends on which machine among several machines manufactures or manufactured the object and thus also its opening, wherein the position and/or shape varies specific to a machine from machine to machine. The symbol, here for example the opening with the small slot, is applied by a first machine at a first position on the object, for example, the package, and has a first shape. In contrast, the symbol, here for example the opening with the small slot, is applied by a second machine at a second position on the object, for example, the package, and has a second shape. A distinction is made between different objects on the basis of machine-specific positions and shapes of a respective symbol, such as the opening with the small slot. Wherein a respective object is recognized by the machine learner on the basis of a specific feature which, during the manufacture of the object by the respective machine, is or has been created, i.e. applied, in a machine-specific manner on the object in a manner recognizable from the outside. The machine learner can assign the first position to the first class and the second position to the further class. Accordingly, the machine learner can assign the first form to the first class and the second form to the further class. In an embodiment, an ideal position is provided for a respective position of a symbol and/or an ideal shape is provided as a possible ideal symbol for a respective shape of a symbol, wherein a real position captured by the sensor deviates from the ideal position in a machine-specific manner, and/or wherein a real shape captured by sensor deviates from the ideal shape in a machine-specific manner. The machine learner determines any deviations from the ideal position and/or ideal shape as specific features, for which the database can be used, which has information on ideal positions and/or ideal shapes as ideal symbols. Depending on whether and how much a symbol deviates from an ideal symbol intended for this purpose, i.e. how much symbols resemble or deviate from one another, conclusions are drawn about the manufacture of the object, each object being recognized or identified on the basis of features determined by sensor, for example, symbols, i.e. reference symbols, for example, real positions and/or real shapes of the respective symbols. By means of a respective symbol, it is possible to assign each object to the machine that manufactured it.

It is possible that the reference information comprises image information of an imprinted or stamped machine-readable code, such as, for example, a date of manufacture, a bar code or matrix code, for example, an EAN and/or BAR code, wherein during manufacture such a code is applied by a machine to a package as a reference object. The code comprises as digits, for example, a date and a time, a batch number and/or omissions, which are also applied differently on a respective object during manufacture, depending on the respective machine. It is possible for such a manufacturing process to involve filling an object in the form of a package with the contents, for example, filling material. The respective machine can arrange, for example, print, such digits of the aforementioned code at an edge of the code. The machine learner also recognizes and/or processes such machine-specific codes.

Further advantages and embodiments of the invention follow from the description and the accompanying drawings.

It is understood that the features mentioned above and those to be explained below can be used not only in the combination indicated in each case, but also in other combinations or on their own, without leaving the scope of the present invention.

The invention is illustrated schematically in the drawings using an embodiment example, and is described schematically and in detail below with reference to the drawings.

The drawings show:

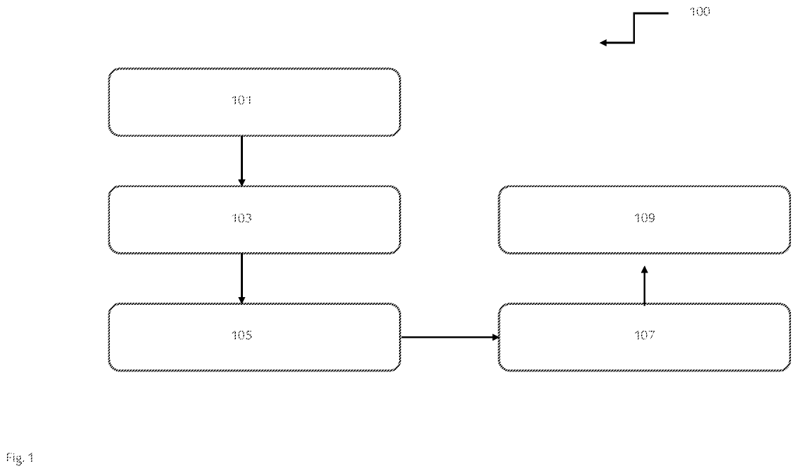

FIG. 1 shows a possible embodiment of the recognition method according to the invention,

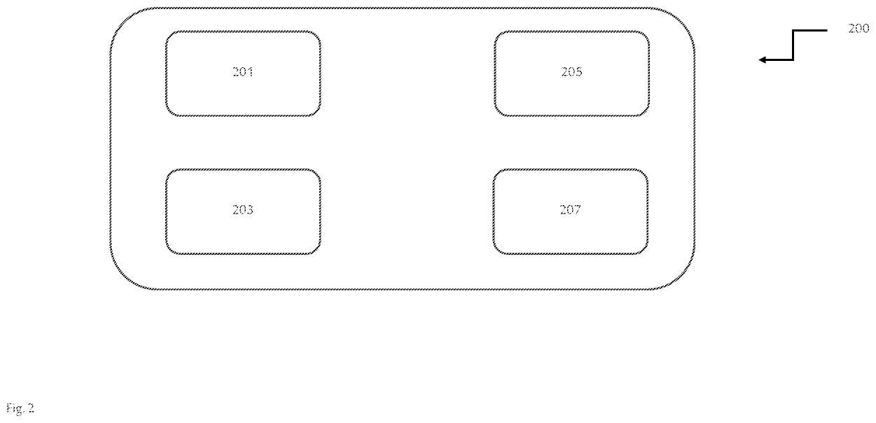

FIG. 2 shows a possible embodiment of the presented recognition system.

FIG. 1 illustrates a computer-implemented recognition method 100 for unambiguously recognizing an object.

The recognition method 100 comprises a first determining step 101 for determining, by means of a first optical sensor at a first point in time, reference information by capturing a number of symbols applied to a reference object.

The first determining step 101 can be performed, for example, by a manufacturer of a reference object during a manufacturing process, for example, using a stationary image capture system. In particular, the reference object can be captured several times during the first determining step, for example, from different recording angles and/or under different lighting conditions.

Alternatively, the first determining step can be performed by a user of a reference object during the first point in time, for example, using a smartphone or an image capture sensor of a smartphone. Instructions can be issued to the user to guide the user in creating different images, for example, from different recording angles and/or under different lighting conditions. Optionally, a user may be directed to determine a video, i.e. a number of contiguous images, of the reference object as reference information. To guide the user, instructions can be issued to the user on a smartphone, for example, acoustically and/or visually.

Furthermore, the recognition method 100 comprises a training step 103 for training a machine learner with reference information and a provided ground truth which assigns respective reference information to a first class, for example, a “valid” class, or to a further class, for example, a “not valid” class.

In particular, the training step 103 may be carried out on a computing unit, such as a server, that is communicatively connected to a sensor for performing the first determining step 101. Accordingly, the computing unit receives sensor data, in particular image data, from the first optical sensor and provides it to the machine learner.

Using a ground truth, the machine learner is trained by means of the sensor data determined in the first determining step 101 as acquired reference information, so that there is a trained machine learner after the training step 103. In particular, reference information determined in the first determining step 101 can be split into two parts which are assigned to a first class or a second or further class by means of the ground truth, so that the machine learner can be trained using only the reference information captured by the sensor. Alternatively or additionally, the machine learner can be trained on the basis of specified reference information, for example, reference information artificially generated or generated by manual manipulations of reference objects.

The ground truth may be provided by a user or manufacturer and may comprise examples or define a classification of when reference information is to be assigned to the first class or the further class.

Furthermore, the recognition method 100 comprises a second determining step 105 for determining, by means of a second optical sensor at a second point in time, sample information by capturing a number of symbols applied to an object to be recognized, i.e., a sample object.

In the second determining step 105, the second optical sensor is used to determine sample information from the object to be recognized. For this purpose, the object to be recognized can be captured by a user using an image capture sensor of a smartphone, for example.

Furthermore, the recognition method 100 comprises an assigning step 107 for the assignment of the sample information to the first class or to the further class by the machine learner.

Once the machine learner is trained, it can carry out an assignment of sample information to the first class or the further class based on its trained logic.

Furthermore, the recognition method 100 comprises an outputting step 109 for outputting a validation signal in case the machine learner assigns the sample information to the first class.

To inform a user of a result of the assigning step 107 or to enable further systems, such as a third-party system, to automatically process the result of the assigning step 107, the result can be output by means of an output unit, such as a display or a communication interface for transmitting result data to a third-party system.

FIG. 2 illustrates a recognition system 200.

The recognition system 200 comprises a first optical sensor 201 configured to determine, at a first point in time, reference information by capturing a number of symbols applied to a reference object, a training module 203 configured to train a machine learner on the basis of the reference information and a provided ground truth which assigns the respective reference information to a first class or a further class, a second optical sensor 205 configured to determine sample information by capturing an object to be recognized, i.e. a sample object, at a second point in time, wherein the sample object has a number of symbols, in particular printed symbols, a classification module 207 configured to assign the sample information to the first class or the further class by means of the machine learner, and an output unit 209 for outputting a validation signal in case the machine learner assigns the sample information to the first class. In further splitting, an invalidation signal is output in case the machine learner assigns the sample information to the further class.

The classification module 207 can be configured, for example, as a processor or subprocessor of a computer system, in particular a smartphone.

The first optical sensor 201 can be, for example, a smartphone or a camera in a production line.

The second optical sensor 205 can be, for example, a smartphone.

1-11. (canceled)

12. A computer-implemented recognition method for unambiguously recognizing an object, comprising:
determining, by means of a first optical sensor at a first point in time, reference information of at least one reference object by capturing a number of symbols applied to a respective reference object;
training a machine learner on the basis of the reference information and a provided ground truth which assigns respective reference information to a first class or a further class;
determining, by means of a second optical sensor at a second point in time, sample information by capturing a number of symbols applied to the object to be recognized;
assigning the sample information to the first class or to the further class by the machine learner; and
outputting a validation signal in case the machine learner assigns the sample information to the first class.

13. The recognition method according to claim 12, wherein the first sensor and the second sensor are identical.

14. The recognition method according to claim 12, wherein the second sensor is formed as an integral part of a mobile computing unit.

15. The recognition method according to claim 12, wherein the ground truth is dynamically updated and the machine learner is dynamically retrained.

16. The recognition method according to claim 12, wherein the recognition method comprises a preprocessing step for preprocessing the reference information and/or the sample information before it is supplied to the machine learner, and wherein the preprocessing step comprises at least one process of the following list of processes:
distinguishing between symbol information and background information by means of a symbol recognition algorithm;
recognizing individual symbols using a symbol recognition algorithm;
converting image information into spectral information by means of a Fourier transformation.

17. The recognition method according to claim 12, wherein the reference information is determined by an entity classified as trustworthy in a manufacturing process of the respective reference object and the sample information is determined by an entity not classified as trustworthy outside a manufacturing process of the object to be recognized.

18. The recognition method according to claim 12, wherein the recognition method comprises a verification step in which respective first sample information provided by a specific user is evaluated by means of a further machine learner, wherein the further machine learner is trained on the basis of second sample information already provided by the user in the past and assigns the first sample information to the first class or the further class.

19. The recognition method according to claim 12, wherein the ground truth assigns reference information showing a deviation of respective, in particular applied or printed reference symbols from an ideal symbol, which is greater than a validation threshold, to the class “not valid”, and assigns reference information showing a deviation of respective, in particular printed reference symbols from an ideal symbol, which is less than or equal to the validation threshold, to the first class.

20. The recognition method according to claim 12, wherein the machine learner is trained on the basis of reference information comprising specific features corresponding to deviations of at least one of the applied symbols from at least one ideal symbol.

21. The recognition method according to claim 20, wherein the specific features are selected from:
deviations in symbols applied to a respective reference object from respective ideal symbols, in particular differences in dots, omissions, smudges, chipping, embossing, abrasion, in particular in the case of printed, stamped, punched, lasered, engraved or embossed characters, graphic symbols and/or codes, and/or
positional deviations of symbols applied to a respective reference object from respective ideal symbols, in particular labels, shrink films and/or imprints in relation to a reference point on the reference object; and/or
positional deviations of symbols applied to a respective reference object from markings or from object components, in particular from corners, edges, closures and/or seams of the reference object; and/or
deviations in reflections, light and/or shadow cast, in particular a shadow cast of a deformable packaging as reference object; and/or
deviations of corners, edges, seams, welds, embossing, curvatures, folds, soiling, repulsions and/or deformations of a respective reference object; and/or
color deviations of a respective reference object; and/or
deviations of contents of a transparent or translucent object as reference object; and/or
deviations in a printing substrate structure, label, film and/or product wrapping of a respective reference object.

22. A recognition system for unambiguously recognizing an object, comprising:
a first optical sensor configured to determine, at a first point in time, reference information of at least one reference object by capturing a number of symbols applied to a respective reference object;
a training module configured to train a machine learner on the basis of the reference information and a provided ground truth which assigns respective reference information to a first class or a further class;
a second optical sensor configured to determine, at a second point in time, sample information by capturing an object to be recognized, wherein the object to be recognized has a number of sample symbols, in particular printed sample symbols;
a classification module configured to assign the sample information to the first class or the further class by means of the machine learner; and
an output unit for outputting a validation signal in case the machine learner assigns the sample information to the first class.
